(19) United States
(12) Patent Application Publication
(10) Pub. No.: US 2025/0196953 A1
(43) Pub. Date: Jun. 19, 2025

(54) Self-Propelled Tandem Axle Trailer

(71) Applicant: New Heights, LLC, Leola, PA (US)

(72) Inventors: Aaron Jay Beiler, Gap, PA (US); Raymond Beiler, New Holland, PA (US); Josiah Harthcock, Lancaster, PA (US); Jeremiah Weaver, Narvon, PA (US); William Fisher, Paradise, PA (US)

(73) Assignee: New Heights, LLC, Leola, PA (US)

(21) Appl. No.: 18/982,884

(22) Filed: Dec. 16, 2024

Related U.S. Application Data
(60) Provisional application No. 63/610,911, filed on Dec. 15, 2023.

(51) Int. Cl. B62D 59/04; B60B 35/00; B60K 17/10; B62D 13/00; B62D 63/06

(52) U.S. Cl. CPC B62D 59/04; B60B 35/004; B62D 13/00; B62D 63/06; B60K 17/10

(57) ABSTRACT

A self-propelled trailer for towing by a power vehicle, comprising: a frame forming an undercarriage chassis; a tandem wheel assembly positioned under the undercarriage chassis and having a rear wheel assembly and a front wheel assembly, the tandem wheel assembly including at least one steering assembly, and at least one drive assembly, and an extension assembly moving the front wheel assembly between trailing position and a self-propelled position where the rear wheel assembly and the front wheel assembly are positioned to equally support the undercarriage chassis and where the trailer can be moved by operation of the at least one drive assembly; and having an extension device pivotably mounted to the frame at a first end and having a repositionable knuckle and a multi-use mount at a second end of the extension device.

### CROSS-REFERENCE TO RELATED APPLICATIONS

This application claims the benefit of the filing date of Provisional Patent Application No. 63/610,911, filed on Dec. 15, 2023.

### FIELD OF THE INVENTION

The invention relates to a self-propelled tandem axle trailer capable of convertibly bearing a container or attachments received on a universal mount.

### BACKGROUND

Workers often find that providing materials for replacement of a building roof is very time consuming, considering the task involves using different mechanical units or manual labor to lift building materials from a truck and position them on a roof. Furthermore, stripping old material from the building roof in order to put on a new roof is also time consuming and a dirty job. Generally, old material is thrown from the roof to the ground around the building and then workers manually pick up debris to deposit it into a disposal container. Even if the material can be thrown directly into a container there remain the problems of getting the disposal container in proximity to the roof and removal from the work site. The most common solution to the disposal problem is to move a dump truck adjacent to the building and to attempt to throw the material directly from the roof into the truck bin. Furthermore, the problem is not limited to roofing material. Any building remodeling generates significant construction trash, and the most convenient method of removing it from the building is to throw it out a window.

As a result, it is not always possible to move a large truck into a location adjacent to a building. Fences, lawns, and shrubs can be damaged by any size truck, especially a large transport truck.

Additionally, there is a need for material handler that can be operated in a self-propelled, and is provided with a mount to accommodate a variety of tools thereon, such that the lifting, and positioning of goods and materials may be facilitated. Such a material handler may beneficially be capable of being converted between carrying a bin, or be used with removable implements, such as forks, or a bucket.

There is a need for a vehicle that can move equipment and travel around the typical landscaped yard surrounding a building and be capable of positioning a storage bin into an extended position near workers, and selectively be used with one or more implements. Such a vehicle should be sturdy enough to handle large loads.

### SUMMARY

In view of the foregoing, a trailer for towing by a power vehicle is provided and generally includes a frame and a tandem wheel assembly. Atop the frame is provided an extension boom, with an end having a repositionable knuckle providing a multi-use mount. The multi-use mount, when the knuckle is in a first position, may receive a carriage attachment bearing a pair of forks, such that the vehicle may operate as a telchandler, with extension and tilting movement of the boom. Tilting control of the forks are possible by a knuckle tilting actuator. The multi-use mount, while the knuckle is in a second position, may securely receive thereon a container that can function as a waste bin, or securely carry a payload therein. The knuckle in the second position may be secured by placement of a locking device, such as a locking pin, to prevent repositioning of the knuckle out of the second position, until such time as the locking pin is removed. The knuckle may be controllably positioned between the first position and the second position by actuation of a knuckle configuration actuator. The frame forms an undercarriage chassis which the tandem wheel assembly is positioned there under. The undercarriage chassis includes a rear wheel assembly, a front wheel assembly, and an extension assembly moving the front wheel assembly between trailing position and a self-propelled position where the rear wheel assembly and the front wheel assembly are positioned to equally support the undercarriage chassis.

In an exemplary embodiment of the invention, there is provided a self-propelled trailer for towing by a power vehicle, comprising: a frame forming an undercarriage chassis; a tandem wheel assembly positioned under the undercarriage chassis and having a rear wheel assembly and a front wheel assembly, the tandem wheel assembly including at least one steering assembly, and at least one drive assembly, and an extension assembly moving the front wheel assembly between trailing position and a self-propelled position where the rear wheel assembly and the front wheel assembly are positioned to equally support the undercarriage chassis and where the trailer can be moved by operation of the at least one drive assembly; and having an extension device pivotably mounted to the frame at a first end and having a repositionable knuckle and a multi-use mount at a second end of the extension device.

In an exemplary embodiment, the frame is a tubular backbone frame formed as a generally hollow body extending between and supporting each of the front wheel assembly and the rear wheel assembly. In another exemplary embodiment, the frame is a ladder frame having a pair of generally parallel longitudinal rails with a plurality of cross braces extended therebetween, the frame supporting each of the front wheel assembly and the rear wheel assembly.

In an exemplary embodiment, the multi-use mount has a carriage assembly mounted thereto. The carriage assembly may provide a pair of forks. In another exemplary embodiment, the multi-use mount has a container assembly mounted thereto.

In an exemplary embodiment, the self-propelled trailer may comprise a control system providing a remote controller device, a power source selected from a combustion engine or a battery, the power source providing the source for motive power through the at least one drive assembly, and power for a plurality of linear actuators. The plurality of linear actuators may be hydraulic actuators, and the at least one drive assembly provides a hydraulic motor for rotating at least one wheel of the tandem wheel assembly.

In an exemplary embodiment, the frame has pivot mount at a first end, with the extension device pivotably mounted to the pivot end.

In an exemplary embodiment, the extension device may be a three stage boom utilizing a chain drive mechanism for extending the extension device, and providing a first extension section, a second extension section that is telescopically received within the first extension section, and a third extension section that is telescopically received within the second extension section. In an exemplary embodiment, the extension device may provide a tilting actuator extended between the frame and the extension device for pivoting the extension device at the pivot mount when the tilting actuator is extended. In an exemplary embodiment, the extension device may have an extension device actuator for telescopically advancing and retracting the extension device, and may further have a knuckle configuration actuator for controllably positioning the knuckle, and may further have a mount tilting actuator for controllably positioning the mount upon the knuckle.

In an exemplary embodiment, the tandem wheel assembly provides each of the front and rear wheel assemblies having drive assemblies for controllably driving the wheels, and each of the front and rear wheel assemblies are provided with a steering assembly.

In an exemplary embodiment, the multi-use mount is configured to receive an implement thereon, the implement selected from the group consisting of storage bin, work platform basket, bucket, and forks. In an exemplary embodiment, where the implement is a storage bin, the storage bin may have a bracket receiver provided on the underside of the storage bin, the storage bin further providing a pair of telescoping support legs at a first end.

In an exemplary embodiment, the storage bin may further provide a fork receiving bracket for storage of the carriage assembly and forks when not secured to the multi-use mount.

In an exemplary embodiment, the extension device may further provide a plurality of hydraulically operated actuators utilizing a plurality of hydraulic lines, the extension device providing a slidingly mounted manifold configured to provide strain relief for the hydraulic lines. The slidingly mounted manifold may be mounted to the first extension device, and sliding movement of the manifold may be dampened by a spring or shock absorber.

### BRIEF DESCRIPTION OF THE DRAWINGS

The invention is explained in greater detail below, with reference to embodiments and the appended drawings of which:

FIG. 1 depicts a left side profile of the self-propelled trailer, with the knuckle positioned downwards in a second position, according to an exemplary embodiment of the invention;

FIG. 2 depicts the profile view of FIG. 1, with the knuckle positioned upwards in a first position, according to an exemplary embodiment of the invention;

FIG. 3 depicts a top view of the self-propelled trailer of FIG. 1;

FIG. 4 depicts a bottom view of the self-propelled trailer of FIG. 1;

FIG. 5 depicts front view of the self-propelled trailer of FIG. 1;

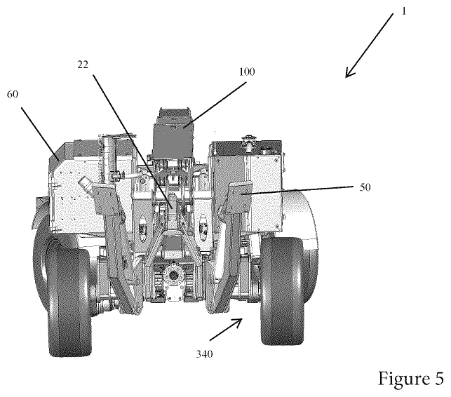

FIG. 6 depicts a rear view of the self-propelled trailer of FIG. 1;

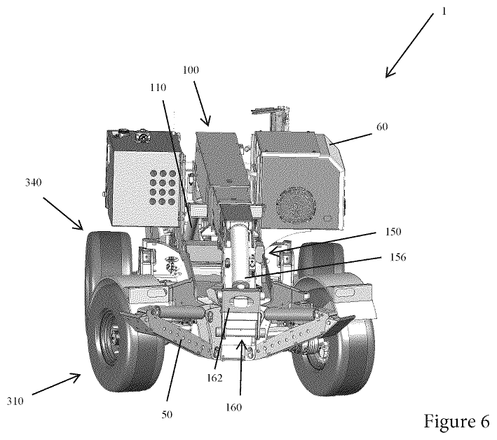

FIG. 7 depicts a rear, ¾ profile view of the self-propelled trailer of FIG. 1;

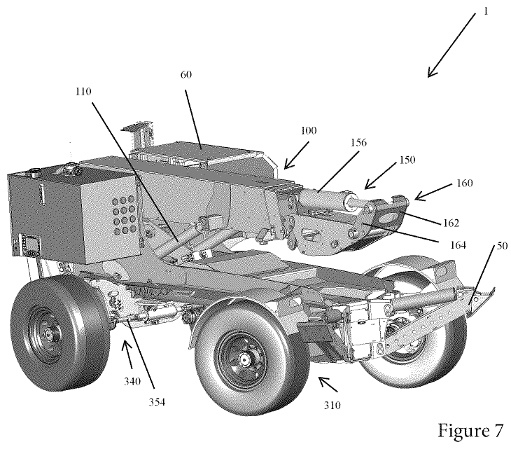

FIG. 8 depicts an enlarged side view of the knuckle and multi-use mount of FIG. 1, according to an exemplary embodiment of the invention;

FIG. 9 depicts the view of FIG. 8, only with a portion of the knuckle depicted as transparent for case of seeing internal aspects of the knuckle;

FIG. 10 depicts an internal detailed view of the extension device, according to an exemplary embodiment of the invention;

FIG. 11 depicts a perspective view of an exemplary storage bin for use with the extension device, according to an exemplary embodiment of the invention;

FIG. 12 depicts a side perspective view of a self-propelled trailer, provided with a carriage assembly and forks on the extension device, according to an exemplary embodiment of the invention;

FIG. 13 depicts a front perspective view of a self-propelled trailer provided with the wheel assembly in a trailering position, according to an exemplary embodiment of the invention;

FIG. 14 depicts a ¾ perspective view of the self-propelled trailer of FIG. 13, with the wheel assembly now positioned in a self-propelled position, according to an exemplary embodiment of the invention; and

FIG. 15 depicts an elevated perspective view of the self-propelled trailer of FIG. 13, with the storage bin opened, and elevated by actuation of an exemplary embodiment of the extension device.

### DETAILED DESCRIPTION OF THE EMBODIMENT(S)

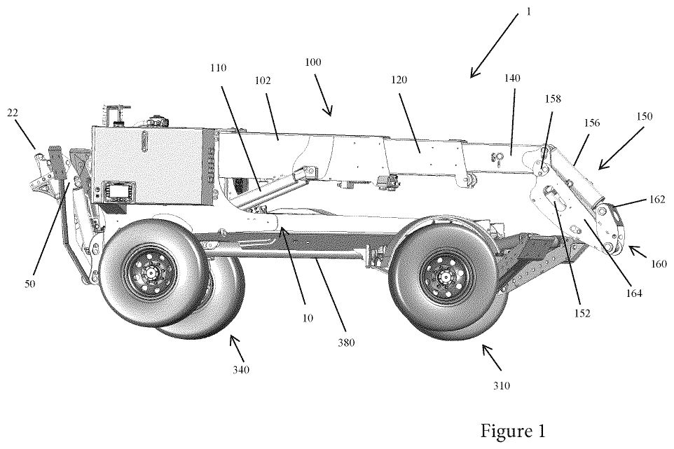

With respect to the Figures a trailer 1 according to the invention is shown having an articulating tow bar, with a coupler. As depicted, the tow bar is in a retracted, and elevated position, such as may be useful when the trailer 1 is employed in a self-propelled manner. As will be familiar to those of skill in the art, the positioning of the tow bar may be adjusted through the extension or retraction of an actuator, such as a hydraulic actuator, whereby the articulating tow bar may be extended downwards, being caused to pivot where the tow bar is attached to the trailer 1 in order to put the tow bar and coupler in a lowered position that can be mounted to a tow hitch ball mount of a tow vehicle. In this manner, the trailer 1 may be put in a ready position for securement to, and towing by a power vehicle, such as a truck with a tow hitch. The tow bar actuator may be controlled, i.e., retracted, to raise the tow bar into the position shown in FIG. 1, with the tow bar and coupler raised, and provide a more compact arrangement for the trailer 1, such that it can be operated in a self-propelled manner, and the tow bar is positioned in compact, stowed position, as shown.

The trailer 1 generally includes the following major components: a frame 10, a control system 60, multi-use mount 160 configured to receive an attachment thereon, such as a storage bin or a carriage assembly with a utility device, such as associated forks, and an extension device 100, and a tandem wheel assembly 300.

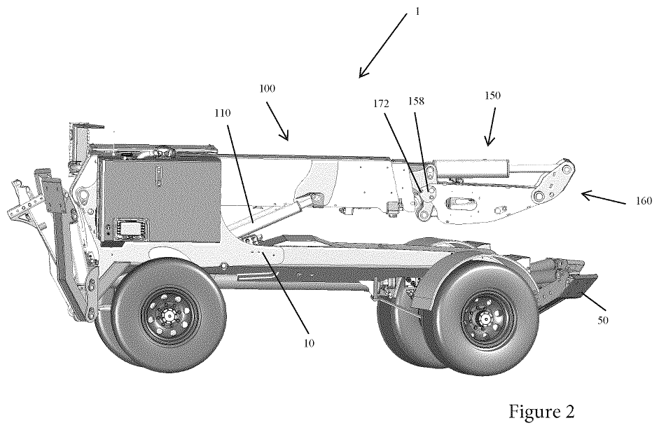

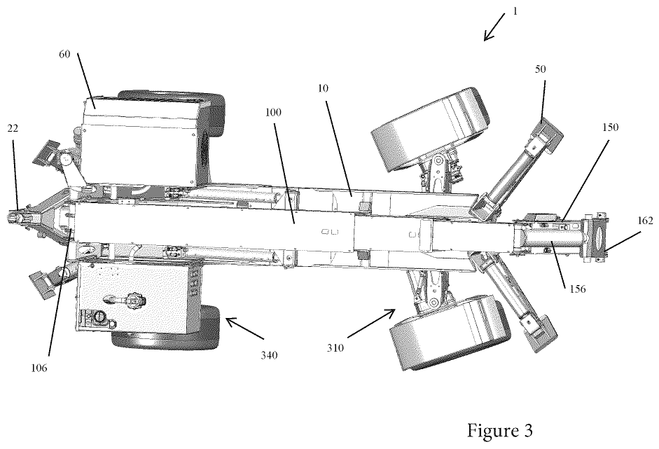

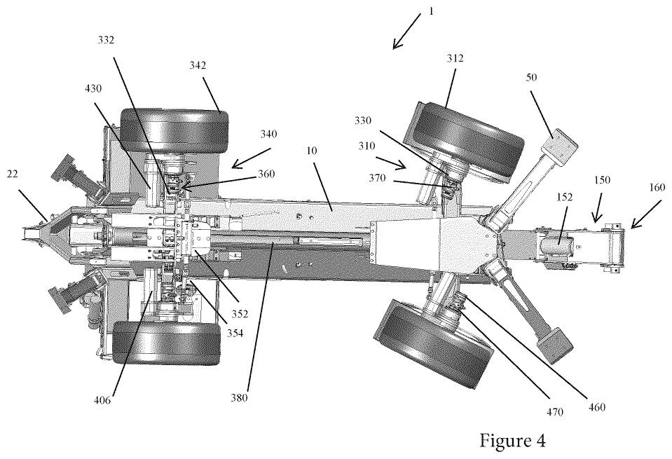

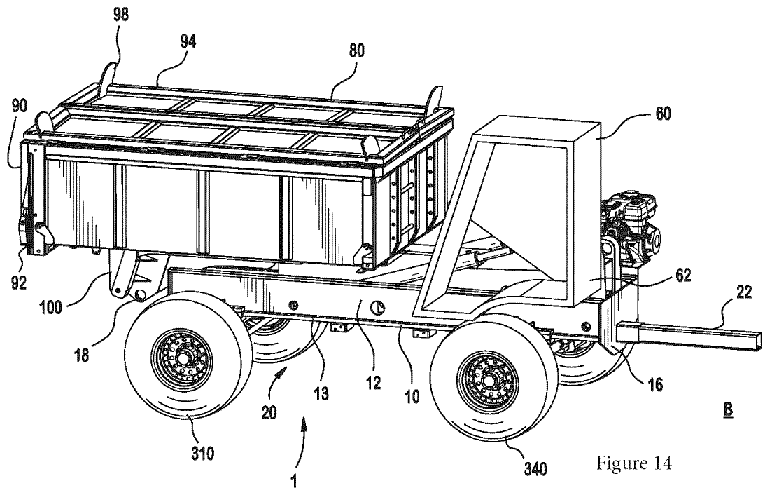

Now with reference to Figures, the frame 10 is supported atop a tandem wheel assembly. The frame 10 supports an extension device, or extension boom. The frame 10 provides a reconfigurable trailer hitch 22, and a plurality of stabilizer arms 50, that can be deployed as outriggers to stabilize the invention when in a mode of operation that requires extension actuation of the extension device 100, or when the trailer is to remain in a fixed position. The frame may be any suitable frame for supporting the loads applied to the trailer 1 through operations with the trailer, including trailering, self-propelled movement, as well as any loads applied to the trailer frame 10 by way of the extension device 100 when carrying a load within a bin, or a load on any implement mounted to the multi-use mount of the extension device, as will be discussed. In an embodiment, the frame 10 may be a ladder frame having a pair of frame rails which may be parallel, but may also be non-parallel frame rails, and secured relative to each other by multiple cross-beams extending between each of the frame rails to form a ladder arrangement. In another embodiment, the frame may be generally hollow body, forming a tubular backbone, which may be of generally rectangular cross section, as depicted in FIGS. 1-4. In an embodiment, the frame 10 may be a tubular, hollow body extending at least between the front wheel assembly 340 and the rear wheel assembly 310, when in the self-propelled mode depicted in FIG. 14. Other components for the trailer may be mounted to the frame 10, such as the extension device, the wheel assemblies 310, 340, and articulating tow hitch. At the front end of the frame, there is provided a pivoting securement of the articulating trailer hitch 22. At the rear of the frame, a pair of stabilizing arms 50 may be pivotably secured to the frame 10. Another pair of stabilizing arms 50 may be secured relative to the frame near the front end of the frame, as depicted in FIG. 4.

As shown, in an exemplary embodiment of the invention, the trailer connection section 22 is a trailer hitch 22 positioned and connected to an end of the frame 10. The trailer hitch 22 includes a coupler or suitable connector for connecting with a truck (i.e., ball mount). The trailer hitch is controlled by an actuator such that the trailer hitch can be retracted, as shown in the figures, or extended downwards to be generally parallel to the ground, and position the ball mount at a level that can be mounted to a tow vehicle.

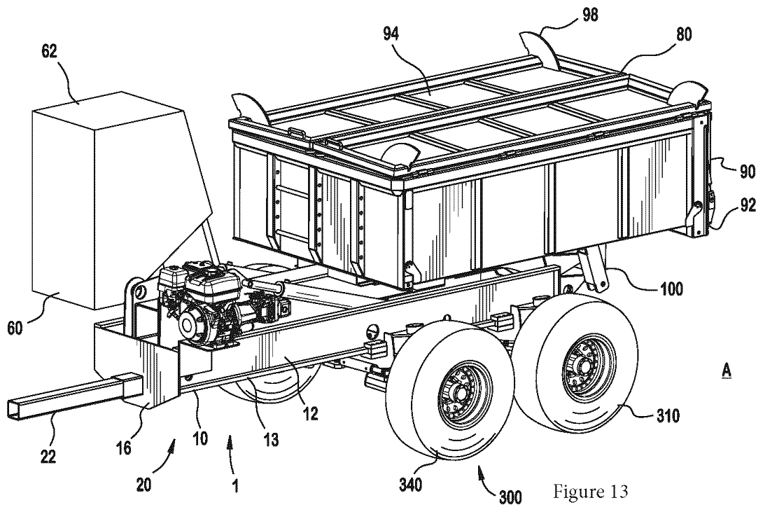

According to an embodiment of the invention, and with reference to FIGS. 13, and 14, the trailer 1 includes a tandem wheel assembly 300. In an exemplary embodiment of the invention, the tandem wheel assembly 300 is positioned under the undercarriage chassis 20 and generally includes a rear wheel assembly 310, a front wheel assembly 340, and an extension assembly 380.

As shown in FIGS. 13 and 14, in an exemplary embodiment of the invention, the rear wheel assembly 310 includes a rear drive assembly 330 according to the invention. In an exemplary embodiment of the invention, the rear drive assembly 330 includes a hydraulic motor assembly 332 and provides a brake rotor (not shown), and an engagement assembly 370 for each rear wheel 312. Such drive assemblies and engagement assemblies are known and will be familiar to those of skill in the art. In an embodiment, rear wheel assembly 310 may be steerable, as discussed below. However, one skilled in the art should appreciate that the rear wheels assembly 310 may be non-steerable.

In an embodiment of the invention, the motor assembly 362 for the rear wheel assembly generally includes a motor, such as a hydraulic, or electric motor for powering an associated wheel. The motor may be operationally connected to the control system 60, for example, through the use of hydraulic lines (not shown).

Many of the power system components are not shown for sake of complexity in the drawings, although a discussion is provided for purposes of enabling one skilled in the art to understand how the drive system is assembled and performed. One skilled in art should appreciate that other designs are possible. For instance, the rear drive assembly 330 may include other methods to move the rear wheels 312, including chains, belts, or a drive shaft and a transmission connected to a combustion or electric engine, so that trailer 1 can be moved around a work site under its own power.

As shown in FIGS. 13 and 14, the front wheel assembly 340 includes a pair of front wheels 342, a front wheel frame 344, a front steering 350 assembly, and a front drive assembly 360.

In the embodiment shown, the front wheel assembly 340 includes steering capability using a front steering assembly 350 according to the invention. However, one skilled in the art should appreciate that the front wheels 342 may be non-steerable. While it is recognized that the trailer may be operable without a steering assembly, such as where the drive assemblies for each side (i.e., the left or the right pair of wheels) may be operated independently, such that the trailer 1 may be operated in a manner similar to a skid steer, it is contemplated that in a preferred embodiment, at least one of the front or rear wheel assemblies 340, 310 would be steerable, such that the trailer may navigate around obstacles while in self-propelled manner. As shown, the front steering assembly includes a steering bracket 352, a pair of steering arms 354 connected to the steering bracket 352 and the pair of front wheels 342. It is contemplated that a similar steering assembly for the rear wheels may be provided, with similar components.

As shown in FIG. 4, in an exemplary embodiment of the invention, the front wheel assembly 340 may include a front drive assembly 360 according to the invention, as discussed above with reference to the rear wheel assembly 310. However, one skilled in the art should appreciate that these front wheels 342 may be non-driveable, without a drive system.

In an exemplary embodiment of the invention, the front drive assembly 360 generally includes a hydraulic motor assembly 362 and a rotor assembly 364, and an engagement assembly 370 for each front wheel 342. The engagement assembly may be any suitable mechanism for selective actuating the clutch, or mechanism for engaging the drive force between the motor and the wheel. It is necessary that the motor be capable of being disengaged from the wheel, in order to allow for towing of the trailer 1, yet still be capable of having the motor engage with the wheel, in order to allow self-propelled operation of the trailer, when the self-propelled mode is selectively engaged.

In an embodiment of the invention, the motor assembly 362 generally includes a motor, such as a hydraulic, or electric motor for powering an associated wheel. The motor may be operationally connected to the control system 60, for example, through the use of hydraulic lines (not shown).

Many of the power system components are not shown for sake of complexity in the drawings, although a discussion is provided for purposes of enabling one skilled in the art to understand how the drive system is assembled and performed. One skilled in art should appreciate that other designs are possible. For instance, the front drive assembly 360 may include other methods to move the front wheels 342, including chains, belts, or a drive shaft and a transmission connected to a combustion or electric engine, so that trailer 1 can be moved around a work site under its own power.

Each hub assembly for each of the wheel assemblies for the trailer 1 may have a brake assembly by which the rotation of the wheels on the wheel assembly may be selectively slowed, or stopped from rotation (not shown), as will be familiar to those of skill in the art. In an embodiment, the brake assembly may be a rotor and caliper, which may be operated in any suitable fashion known to those of skill in the art, for example, through the use of an electronic brake caliper, or a hydraulically operated brake caliper for applying a braking force to each wheel.

Each of the hub assemblies may have a suspension assembly that allows the independent movement of the wheel hub, relative to the wheel assembly frame, and the trailer it is affixed to, as the trailer traverses uneven ground. The suspension system may be any suitable suspension known to those skilled in the art, and be capable of allowing at least some freedom of movement, generally in a vertical direction, relative to the frame of the trailer. In the embodiment depicted in FIG. 4, the suspension assembly 406 for each of the hub assemblies may be a torsion suspension system, providing an exterior housing of a square profile tube affixed by a bracket to a suspension mount fixed on the frame, and which may be pivotably secured to the wheel assembly. The suspension assembly 406 may provide for example, a torsion rod suspension, as shown, and as will be familiar to those of skill in the art. In an embodiment, the suspension assembly, in a resting state, may have one or more deformable elements in the form of elastic cords that are situated against flat surfaces of an interior square profiled torsion rod, and simultaneously situated in the corners within the exterior housing 430. The interior square torsion rod may be fixedly secured to the sprung portion of the hub assembly, and when caused to be rotated as the suspension travels, the clastic portion of the suspension is resiliently deformed within the exterior housing 430, thereby dampening and controlling the vertical movement of the respective wheel, relative to the frame 10. It is contemplated that the torsion suspension components need not be limited to being square in cross-section, and other cross-section profiles, so long as the interior rod may rotate within the confines of the exterior housing, where the rotation induces resilient deflection in the deformable elements between the exterior housing and internal rod components.

In an embodiment, the torsion arm 438 may be secured to any portion of the suspended wheel hub assembly to which the hub for a wheel is to be mounted. Torsion rod suspensions are known in the prior art, and it is contemplated that variations of the teachings herein applying a suspension device to allow relative movement of the wheel relative to the frame would fall within the spirit of the teachings herein.

As will be familiar to those of skill in the art, each wheel or each of the front or rear wheel assemblies 310, 340 may be provided with a selectively engageable clutch mechanism, allowing each wheel of a wheel assembly to be driven by the motor, or to allow the hub/wheel to free-wheel independently of any rotation of the driveshaft. While the clutch is engaged (not shown), motive forces provided by the motor 470 are directed through the transmission 460, if any, and then by the driveshaft 474, whereby the motive forces may be passed through the clutch mechanism 500 to cause the rotation of the hub assembly upon which the wheel is mounted, thereby driving the wheel. While the clutch is disengaged, the wheel and hub assembly may spin freely, independent of the driveshaft and/or motor 470, as may be required while the trailer 1 is being towed by a powered vehicle between locations. The clutch mechanism may be of any suitable type for selectively transmitting torque from the motor to the wheel, as is understood by those skilled in the art, and may include friction, centrifugal, diaphragm, positive, hydraulic, electromagnetic, or vacuum clutches, as non-limiting examples.

Thus, it is contemplated that in embodiments of the trailer 1, the drive assemblies may be provided for at least one of the front or rear wheel assemblies 310, 340, and may be provided for both the front and rear wheel assemblies. Additionally, the steering capability may be provide for either the front or rear wheel assemblies 310, 340, or for both of the wheel assemblies. Thus, it is contemplated that the trailer, in various embodiments, may be any of front wheel drive, rear wheel drive, or all-wheel (4 wheel) drive; and similarly, may be any of front wheel steering, rear wheel steering, or all wheel steering, as appropriate for the planned usage of the trailer 1.

Now with reference to the Figures, the control system 60 will be discussed and generally includes a power system source (i.e., combustion engine, battery) and a control assembly connected (hydraulic and electrical lines) to the rear wheel assembly 310, the front wheel assembly 340, and the extension assembly 100. In an embodiment, user operation of the control system may be performed by remote control, with the operator safely removed from the vehicle. In an embodiment, controls may be accessible from the trailer, such as where an operator may be provided with a cage, or stage, where the controller is to remain on the trailer for operation. In an embodiment, where the controller is via a control device removed from the trailer, allowing the operator to walk alongside, or remain in the vicinity of the trailer, but not necessarily remain on the trailer, the operator may utilize a handheld, separable controller unit, and communicate in any suitable manner, e.g. by wire, or wirelessly, with the vehicle to operate the functions of the control assembly 60, using any one of servos, or mechanical and/or electronic controllers to actuate and operate any of the drive system (and brake assemblies), and the operations of the vehicle, for example, the power, steering, braking, stabilizers, as well as actuators for the extension device 100 (i.e., boom assembly), and control of the carriage or storage bin or implements, when positioned on the multi-use mount. If wireless control is provided, the vehicle may be provided with a receiving antenna to receive control signals from the controller. It is contemplated that one or more sensors may be provided to monitor positions of components of the trailer, to monitor weight distribution, position, and/or balance of loads associated with the extension device, such that the trailer may operate in a safe manner, and avoid potential for overturning of the trailer when operated.

As mentioned previously, the front wheel assembly 340 may be adjustable between positions, to allow use of the trailer in various modes. In a trailing position, the front wheels 342 of the front wheel assembly 340 are positioned adjacent to the rear wheels 312 of the rear wheel assembly 310; while in the self-propelled position B the front wheels 342 are positioned to equally support the undercarriage chassis 20 and, for example, the storage bin 80 if present, or fork prongs on the carriage assembly. The positioning of front wheels may be adjusted by an actuator for the extension assembly 380.

According to the invention, the front wheels 342 are positioned between the trailing position A, as represented by the position of the front wheels in FIG. 13, and the self-propelled position B, as represented by the position of the front wheels in FIG. 14, with the repositioning of the front wheels being performed by actuation of the extension assembly 380, using an actuator as will be familiar to those of skill in the art, such as a hydraulic actuator. The extension assembly actuator may be a known hydraulic cylinder having a barrel, a piston, piston rod, seals, and scal glands. However, one skilled in the art should appreciate that other actuator systems operated by a source of energy, such as electric current, hydraulic fluid pressure, or pneumatic pressure. The extension assembly is depicted in FIG. 4. When the wheel assembly extension actuator is retracted, the front wheel assembly is urged into trailering position, depicted in FIG. 13, and when the wheel assembly extension actuator is extended, the front wheel assembly 340 is urged into the position depicted in FIG. 14.

Now with references to the Figures, the extension device 100 according to the invention will be described. The extension device 100 provided for use with the trailer 1 may be any suitable telescoping arm capable of being pivotably secured at a first end, and provided with a second end that can receive an implement, tool, or bin thereon, as will be familiar to those of skill in the art. In an embodiment, the extension device may have a mount, such as a universal mount to receive standardized brackets for implements thereon. In an embodiment, the extension device may be three stage boom using any suitable extension mechanism, such as a chain drive. An exemplary embodiment of the extension device 100 is depicted in the figures, and includes the following major components: a first extension section 102, a second extension section 120, and a third extension section 140, and a knuckle 150 and multi-use mount 160 provided at a free end of the extension device.

The first extension section is a hollow tubular metal beam having a first end that is pivotably mounted at a pivot mount 106 to a portion of the frame assembly 10. As depicted, the first extension section may have a generally rectangular cross section. The first extension section 102 may have a second end that forms an opening and provided with a receiving passageway therein. The first extension 102 section may be tilted vertically by actuation of the tilting actuators 110.

The tilting actuators 110 may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure. The tilting actuators 110 are pivotably mounted at a first end to the frame assembly 10. As depicted, a pair of tilting actuators 110 are provided, secured on opposite sides of the first extension section 102. It is contemplated that a single tilting actuator 110 may be provided and mounted atop the frame 10, and to the underside surface of the first extension section. As shown, each of the tilting actuators 106 are pivotably mounted at a second end to the first extension section 102, at a point that is generally at least 50% along the length of the first extension section 102 (i.e., away from the first end). In this manner, as the tilting actuators are extended or retracted, the first extension section is caused to pivot about the pivot mount 106 where the extension section 102 is pivotably secured to the first end of the frame assembly 10. Thus, the extension of the tilting actuators will cause the first extension section 102 to pivot upwards, away from the frame assembly 10, and raise the free end of the extension device 100.

A person of ordinary skill in the art would understand that, in an alternative embodiment, the extension device 100, or a sub-frame (not shown) forming a portion of the frame 10 supporting at least the extension device 100, may be secured to a rotating mount, for example, by being mounted atop a turret component (not shown), as will be familiar to those of skill in the art. In such an embodiment provided with a turret or other rotatable mount, the extension device would be capable of being selectively rotated and traversed laterally, in addition to the extension device 100 being selectively raised, lowered, and/or extended as described herein. In this manner, the implement for the extension device may be applied in a direction that is not necessarily aligned with the longitudinal axis of the frame for the trailer.

The second extension section 120 is a tubular metal beam that is telescopically received within the receiving passageway of the first extension section. The second extension is also of a rectangular cross-section and provides a second receiving passageway. The second extension section is of a smaller dimension in cross-section than that of the first extension section 102, such that the second extension section can be received within the first extension section. The second extension section has a first end slidingly received within the interior of the first extension section 102, and a second end of the second extension section that remains protruding out from the first extension section 102, as depicted in FIG. 1. Similarly, the third extension section 140 is a tubular metal beam, also of rectangular cross-section, and is telescopically received within a second receiving passageway of the second extension section. Each of the ends of the first, second extension sections may feature friction reducing bearing surfaces that will slidingly engage with the telescoping section that is inserted into the respective section, to facilitate sliding movement, and distribute loads more evenly.

Extension of the extension device 100 is performed by actuation of the extension device actuator 210, which is located within the interior of the first, second and third extension sections 102, 120, 140. The extension device actuator 210 may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure. The extension device actuator 210 is mounted at a first end to the first extension section 102, at a position generally near the pivoting mount 106 of the first extension section 102 to the frame assembly 10. The extension device actuator 210 is mounted at a second end to the third extension section 140, at a position generally near the free end of the third extension section, and close to the mount for the knuckle 150. The extension device actuator thus passes through the second extension section but is not secured directly thereto.

The third extension section 140, being telescopically received within the second extension section 120, is able to be extended and retracted from the second extension section 120, within a range of travel, as the extension device actuator is caused to extend or retract. The first end of the third extension section will remain within the interior of the second extension section through it range of travel. The second end of the third extension section 140 will remain outside of the second extension section when retracted, as depicted in FIG. 1. Similarly, the second extension section 120, being telescopically received within the first extension section, is also able to be extended and retracted from the first extension section, within a range of travel, as the extension device actuator is caused to extend or retract.

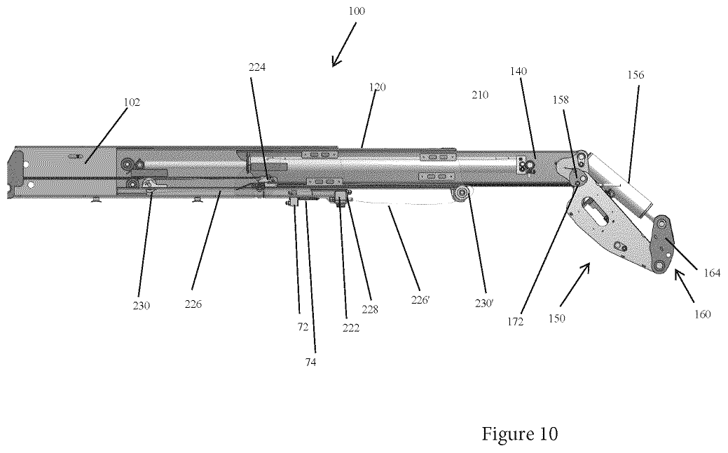

With reference to FIG. 10, an extension balance mechanism 220 is provided to ensure that the extent to which the second extension section 120 is protruding from the first extension section 102 is maintained in an extent that is the same as, or generally proportional to the extent to which the third extension section 140 is protruding from the second extension section 120, through the actuation range of the extension device actuator 210. The extension balance mechanism thus serves to ensure that where the extension device actuator 210 is at a mid-point of extension, each of the third extension section 140, and second extension section 120 will both be at approximately their mid-point of extension travel. In this manner, the extension balance mechanism prevents the possibility of uneven extension of the sections of the extension device; as it would be undesirable to have the second extension barely extended, or not extended at all, while simultaneously having the third extension section be fully extended, when the extension device actuator is at a mid-point of its travel. By providing the extension balance mechanism, loads borne by each of the extension sections of the extension device would be more evenly distributed over the length of the extension device, owing to the proportional movement of each of the second and third extension sections, as the extension device actuator is extended and retracted. Additionally, the extension balance mechanism 220 ensures that a maximum length of each of the telescoping sections 120, 140 is maintained within the portion of the respective extension section it is received within. Such an arrangement would minimize the potential for failure due to concentrating stresses at a single point, as would occur where only one section is fully extended, while the remaining sections would be significantly less extended.

As shown in the figures, the extension balance mechanism comprises a turnbuckle mount 222, an anchor 224, a plurality of flexible couplers 226, turnbuckles 228, and pulleys 230. The flexible couplers 226 may be any suitable device, such as chains, straps, ropes, or cables. As shown in the FIG. 10, each of the flexible couplers may be provided as a pair of parallel positioned flexible couplers, each operating in parallel on opposing sides of a longitudinal axis extending through the center of the extension device 100, though it is contemplated that a single pair of couplers may be provided, oriented generally parallel to, and extending along the longitudinal axis, when viewed from above.

As shown in the FIG. 10, a turnbuckle mount 222 is provided at the free end of the first extension section 102. The turnbuckle mount provides at least one first turnbuckle 228 oriented to extend away from the knuckle 150, and at least one second turnbuckle 228′ oriented to extend towards the knuckle 150. An anchor 224 is secured at the telescopically inserted end of the second extension section 140. As shown, the anchor provides a portion that is positioned within the interior of the second extension section 120, and another portion of the anchor 224 that is positioned to the exterior of the second extension section 120 and fitting within the gap between the exterior of the second extension section 120 and the interior of the first extension section 102. A first pulley 230 is provided within the first extension section 102, at a point near the pivoting end of the first extension section 102. A second pulley 230′ is provided at the telescoping end of the third extension section 140 and positioned to the outside thereof.

A first coupler 226 is secured to the first turnbuckle 228 and extended away from the knuckle 150, then routed around the first pulley 230 to extend in a direction back towards the knuckle 150, and continue on to be secured to the anchor 224, at the anchor point located within the interior of second extension section 120. A second coupler 226′ is secured to the second turnbuckle 228′, and extended in a direction towards the knuckle 150, then routed around the second pulley 230′ to extend in a direction away from the knuckle 150 and continue on to be secured to the anchor 224, at the anchor point located to the exterior of the second extension section 120, and internal to the first extension section 102. Thus, the distance between the first turnbuckle 228 to the first pulley 230, will remain consistent with the distance from the second turnbuckle 228′ to the second pulley 230′, thereby ensuring that each of the second and third telescoping sections would be caused to extend or retract in a similar, or proportional amount.

A knuckle 150 is provided at the free end of the third extension section 140 and has a first end of the knuckle that is pivotably secured to the free end of the third extension section 140. The knuckle further provides a multi-use mount 160, such as a universal mount, that can selectively receive an attachment or one or more implements thereon. The multi-use mount 160 is pivotably secured to the end of the knuckle 150, at the end of the knuckle 150 positioned away from the extension section. The multi-use mount 160 is also pivotably secured to an end of a mount tilting actuator 156, which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure.

In an embodiment, the multi-use mount 160 has a pair of side plates 164 positioned on opposite lateral sides of the mount 160, each being pivotably secured to either side of the second end of the mount tilting actuator 156, and also on either side of the second end of the knuckle 150. On the front face of the mount 160, as depicted in FIG. 1, there is provided a receiver adapter configured for securement to any suitable implement, and securely affixed to each of the side plates of the multi-use mount 160.

An attachment, such as a tool, implement, or bin, that is selectively securable to the multi-use mount 160 may be any suitable implement provided with a receiving bracket to allow securement of the attachment onto the mount 160. Such securement would be selectively releasable, such that the multi-use mount 160 may be disengaged from the receiving bracket of any attached implement, thereby allowing the use with a variety of suitable attachment implements or devices. In an embodiment, the attachment may be for securing a storage bin onto the mount 160, or alternatively, a carriage assembly having at least one fork mounted thereon. In an embodiment, a pair of forks are provided on the carriage assembly, such that the vehicle, using the actuators 210, 110 to position the end of the extension device 100, and along with the mount tilting actuator 156 allow the user to controllably tilt and move mount 160, and thus controllably position the implement, or carriage assembly temporarily secured thereto, whereby the trailer 1 can perform functions similar to a forklift. In an embodiment, the implement may be any suitable implement, including, as non-limiting examples, a bucket, a personnel basket or platform, a hook block, or other rigging device, or other implement as may be useful for lifting and handling of materials.

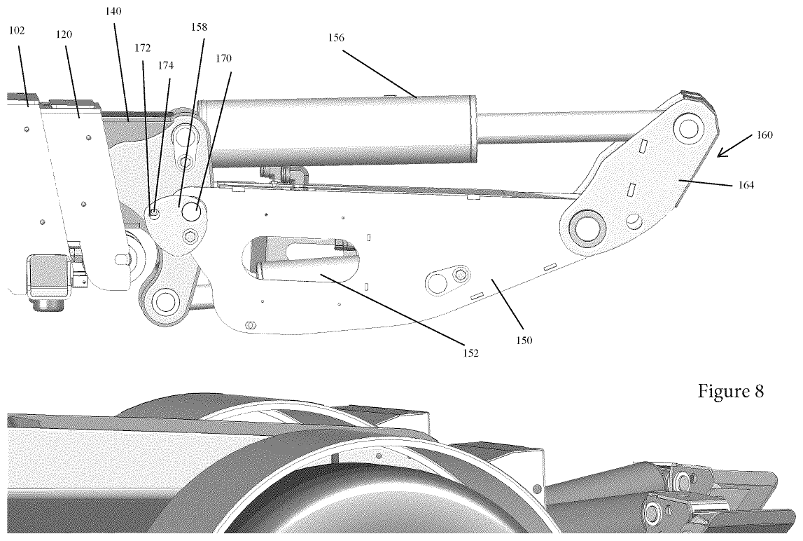

With reference to FIGS. 8 and 10, the knuckle 150 can be seen to be repositionable between at least a first position, and a second position, and positions therebetween, by controllably actuating a knuckle configuration actuator 152, which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure. The knuckle configuration actuator 152, when retracted, will lower the second end knuckle, relative to the third extension section 140 place the knuckle into the first position depicted in FIG. 10, characterized by the knuckle being tilted downwards from the top surface of the extension assembly 100, as shown in the FIG. 10. Conversely, when the knuckle configuration actuator 152 is extended, the second end of the knuckle will be urged upwards into a second position depicted in FIG. 8, characterized by the length dimension of the knuckle 150 being generally parallel to the top of the extension assembly 100. It is contemplated that each of the knuckle configuration actuator 152 and mount tilting actuator 156 may be further extended or retracted than as shown in the figures, such that the knuckle may be caused to move beyond the representative positions depicted in FIGS. 8 and 10, with adjustments to the components for such movements as will be understood by those of skill in the art.

While the knuckle 150 is being urged between the first position of FIG. 10, and the second position of FIG. 8 by actuation of the knuckle configuration actuator 152, a swing plate 158 pivotably mounted to the knuckle 150 and the third extension section 140 will be caused to rotate about a pivot point 170. In an embodiment, the swing plate 158 provides a locking hole 172, and the third extension section 140 provides a corresponding securing hole 174. When the knuckle 150 is in the second position, the locking hole and the securing hole will be placed in alignment with each other, such that a locking pin (not shown), such as a rigid rod, may be inserted through the locking hole 172 in the swing plate 158 and received in the securing hole 174 of the third extension section 140. The locking pin, when so placed, will lock the position of the knuckle 150 relative to the third extension section 140, such that the knuckle will be unable to be moved out of the second position, until such a time as the locking pin is removed.

The locking pin ensures that the knuckle the remains generally parallel to the top of the extension sections. In this configuration, the multi-use mount is positioned such that a storage container, having a corresponding mount portion, may be secured to the multi-use mount, and the storage bin can rest upon the top surface of the extension assembly, when in a retracted, or fully extended state.

With the locking pin removed, the knuckle 150 configuration actuator is able to retract, and cause the knuckle to revert to the first position, and as shown in the FIG. 10, and with the mount-end of the knuckle being angled downwards away from the top of the third extension section 140, as the knuckle 150 is caused to pivot about the point 170 the knuckle is mounted to the third extension section. When the knuckle 150 is moved out of the second position, the swing plate 158 will be caused to pivot as well, and the locking hole and securing hole will no longer being in alignment, as shown in the FIG. 10.

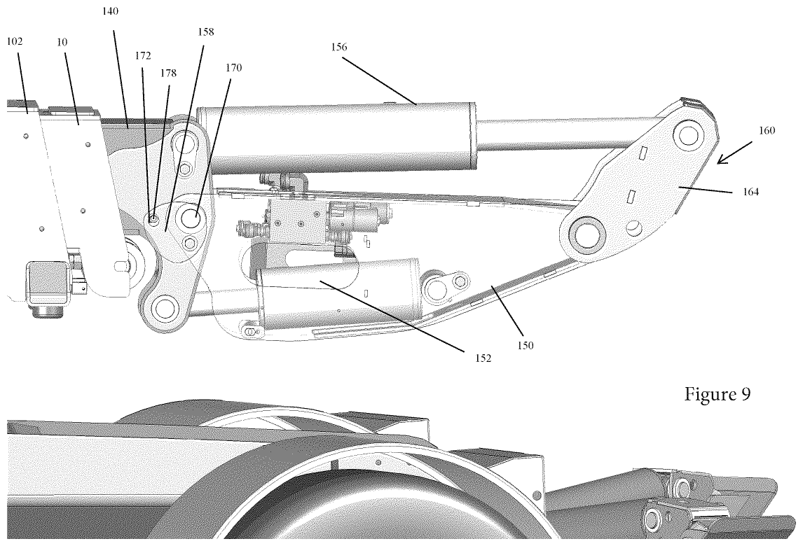

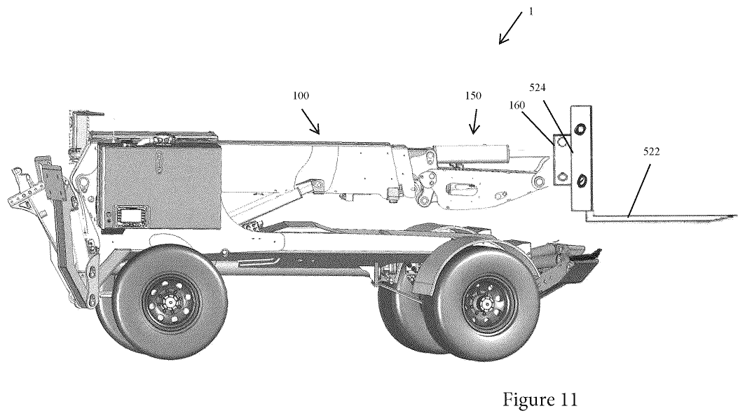

In another exemplary embodiment, rather than a locking pin being required to lock the relative position of the knuckle 150, the locking hole 172 of the swing plate 158, when in the second position of FIG. 9, will be positioned generally in alignment with a proximity sensor 178 mounted on the end of the third extension section, in lieu of the locking hole 174 of FIG. 8. The proximity sensor 178 is able to distinguish if the locking hole 172 is positioned in opposition and within the detectable field of the proximity sensor 178, or alternatively, will detect if a portion of the swing plate 158 is positioned in the detection zone of the proximity sensor. So long as the proximity sensor 178 detects the swing plate (and not detecting the opening in the swing plate from locking hole 172), the knuckle 150 will be deemed to be not in the second position. Only when the proximity sensor 178 detects the locking hole 172 in the swing plate 158, noted by the absence of the swing plate 158 being detected by the proximity sensor 178, then the knuckle 150 will be considered as being in the second position, and the knuckle will be recognized as being in a condition for mounting a container 184 from FIG. 11 onto the multi-use mount 160.

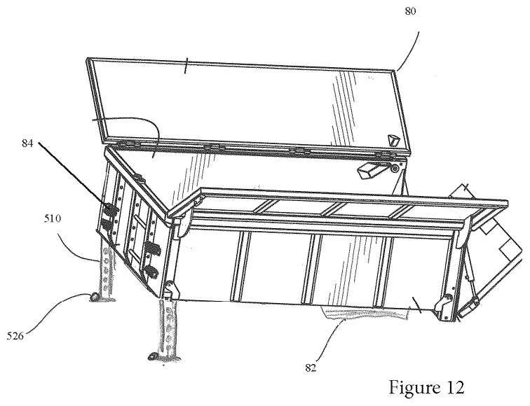

The knuckle 150 thus is pivotably secured at a first end to third extension section 140, and provides a second end pivotably secured to the multi-use mount 160. Additionally, and as can be seen with reference to FIG. 9, where a portion of the knuckle is depicted as semi-transparent to allow viewing of internal aspects of the knuckle 150, there is provided a knuckle configuration actuator 152 having a first end pivotably mounted to the end of the third extension section, and a second end pivotably secured to a bracket 182 for the knuckle, located at approximately a mid-point along the length of the knuckle 150. Furthermore, the mount tilting actuator 156 is depicted being pivotably secured to the free end of the third extension section 140, and has a second end of the mount tilting actuator 156 that is pivotably secured to the top of the multi-use mount 160, as depicted in FIG. 9. Each of mount-tilting actuator and the knuckle configuration actuator 152 may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure are possible. Extension and retraction mount tilting actuator 156 will cause the multi-use mount 160 to pivot about the pivot point 190, where the mount 160 is secured to the body of the knuckle 150, as shown in the FIG. 9. The multi-use mount 160 thus may be caused to tilt forwards or backwards, depending on the actuation of the mount tilting actuator 156. In this manner, an implement secured to the multi-use mount 160, such as a carriage assembly 524 bearing a pair of forks 522 as depicted in FIG. 12, may be articulated, such that the angle the forks protrude, relative to the extension device 100, may be controlled by the user, within a range determined by the range of travel of the mount tilting actuator 156.

The combination of a trailer 1 having an extension device 100, coupled with the various actuators 110, 210 associated with the extension device 100, and those actuators 152, 156 associated with the knuckle 150, may require long lengths of flexible hydraulic lines, in order to provide pressurized fluid for operation of the various actuators. Such flexible lines often are under very high pressure, which may result in increases in thickness of the lines when under high pressure. Additionally, when depressurized, the lines would tend to return to their original length. It is anticipated that with the length of the flexible pressurized fluid lines necessary for operation of the invention, that such lines may vary in length by an amount that would require strain relief. Absent such strain relief, when the lines swell, the tension would be directed to the point where the lines are secured to a fixed point, and likely leading to loss of pressure as the lines would sever their coupling connection to the fixed point. Accordingly, to compensate for hydraulic lines swelling in thickness when pressurized, the lines may be secured to a slidingly mounted manifold 72. Accordingly, as can be seen with reference to the FIG. 1, the manifold 72, to which the hydraulic lines would be connected is slidingly secured to the first extension section 102, at a point that is near the free end of the first extension section. The sliding manifold may be slidingly received in grooves provided within the first extension section 102, and the movement of the manifold then be dampened with a plurality of dampening devices (e.g. springs and/or shock absorbers) that are secured at a first end to the slidingly mounted manifold, and at a second end to a fixed mount on the first extension section. Thus, the present invention provides a spring dampened slidable manifold, such that, as pressurized lines are caused to swell, and tend to shorten in length, the resulting tension in the lines is relieved by the springs, as the manifold is able to slide in an amount that compensates for the tension in the lines. Subsequently, as the lines are depressurized, the springs will return the manifold 72 to the initial location, and prevent damage to the lines due to pressure cycles.

Now with reference to Figures operation of the trailer 1 according to the invention will be described.

The trailer 1 may be trailered to a work site by a tow vehicle, where the trailer is coupled by the tow hitch 22 to a ball mount on the back of the tow vehicle. While being trailered, the trailer 1 would be provided with the front wheel assembly 340 as positioned in FIG. 13, and the articulating tow hitch 22 lowered down from the position depicted in FIG. 1, such that the coupler for the tow hitch is lowered into position to match the height of the ball mount for the tow vehicle. In the towing configuration, the tow hitch would be generally level with a portion of the frame 10. Once at the work site, the trailer 1 may be removed from the trailer by converting the trailer 1 from the towing configuration of FIG. 13, into the self-propelled configuration of FIG. 14, by actuation of the actuator for the extension assembly 380, in order to urge the front wheel assembly 340 towards the trailer hitch end of the frame 22, in a manner that will be familiar to those of skill in the art. Once the trailer is provided with the weight of the trailer spread generally evenly distributed between the front and rear wheel assemblies, as shown in FIG. 14, and with the brakes for the drive assembly of the trailer engaged, the articulating tow hitch 22 may be raised, to separate the trailer from the tow vehicle.

The trailer may then be operated in a self-propelled fashion, with the operator using the controller, such as a remote controller, to controllably navigate the trailer 1 in the self-propelled manner to the desired position at the work site. The drive may thus controllably actuate the drive assembly for motive and braking force directed to each respective wheel for either or both of the wheel assemblies, along with the steering commands for one or both of the wheel assemblies, as will be familiar too those of skill in the art. With the trailer positioned and oriented at the desired location, the brakes are applied to stop the movement of the trailer. The stabilizing arms 50 may be deployed to provide improved stability, by increasing the footprint size beyond that provided by the wheels, with the stabilizing arms lowered to raise the wheels off of the ground, or substantially lessen the loading upon the wheels, as will be familiar to those of skill in the art.

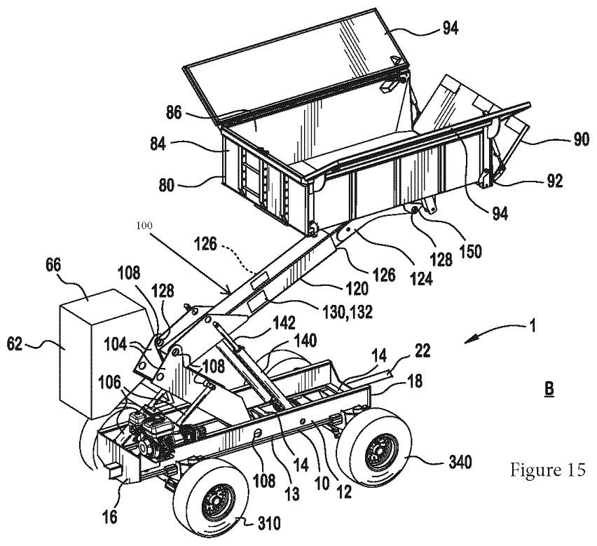

In an embodiment, where the trailer 1 is to be utilized with the storage bin 80 as the implement attached to the multi-use mount 160, the knuckle configuration actuator 152 is extended to place the knuckle 150 in a second position, as depicted in FIGS. 8 and 9, and, in an embodiment of FIG. 8 using a locking pin, the locking pin inserted through the locking hole 172 into the securing hole 174, in order to secure the knuckle 150 in the second position. While in the second position of FIG. 9, the knuckle would be positioned to be attached to any implement having a bracket that supports a load to be placed above the knuckle 150, such as a storage bin 80, though similarly, the trailer could support a work platform basket, as found with scissor lifts, or a work bucket, such as often provided with a cherry picker lift. In this configuration, the mount 160 may support a storage bin 80 as depicted in the FIGS. 13, 14 and 15, where attachment of the bin is secured to the multi-use mount by the receiving bracket 82.

In an embodiment of FIG. 9 having a proximity sensor 178 provided in place of the securing hole, when the knuckle 150 is urged into the second position, as confirmed by the proximity sensor, then the storage bin 80 by an attachment bracket may be secured to the multi-use mount 160. The storage bin 80 as depicted in FIG. 11, may be provided with a bracket 82 positioned on the underside of the storage bin 80. The bracket is positioned to be securely mounted to the multi-use mount 160 when it is urged into the second position. The bracket may be bolted, or rely on selectively releasable locking mechanism, as will be familiar to those of skill in the art, in order to secure the bin 80 to the mount 160, but wherein the securement is reversible in order to allow the multi-use mount to free to engage with other implements, as will be described.

With the bin 80 secured to the mount 160, actuation of the extension device may be operated to raise, lower, and tilt the bin as needed by the operator actuating any of the actuators 110, 210, 152, 156 for the extension device 100. The tilting actuator 110 may raise the extension device upwards from the frame 10, pivoting about the pivot mount 106. The extension device actuator controls the length of the extension device 100, by telescopically advancing the second extension section 120 and the third extension section 140 out from the first extension section 102, with the increase in effective length of the extension device further raising the bin 80, when the extension device has been tilted upwards. The bin 80 may be tilted by actuation of the mount tilting actuator 156, such that the bin 80 may be tilted away from the trailer 1, in order to cause the contents of the bin 80 to be dumped out the selectively lowered end wall opening of the bin, as will be familiar to those of skill in the art.

Removal of the bin 80 from the trailer is performed by returning the extension device to its lowered position, placing the second end of the bin 80 at ground level. The bin 80 is provided with telescopic legs 510 on either side of the bin, at the first end of the bin, located closest to the pivot mount 106 when the bin 80 is mounted onto the extension device. The telescopic legs may be adjustably lowered to place the foot support at ground level, and thus support the elevated first end of the bin 80, whereupon the multi-use mount 160 may be released from securement to the receiving bracket 82 on the underside of the bin 80, through any suitable disengagement procedure, as will be familiar to those of skill in the art. Subsequently, the knuckle 150, and mount 160 may be withdrawn from being underneath the bin 80, whether by reverse movement of the trailer, or retraction of the extension device 100. Such that the multi-use mount is removed from the bin, leaving the near end of the bin elevated and supported upon the telescopic legs, in order to facilitate reengagement of the trailer 1 to the bin 80 at a later point.

With the locking pin, if present, removed, the knuckle 150 may now be lowered for use with other implements, such as the carriage assembly for forklift forks, as depicted in FIG. 12. With the container bin 80 removed, the knuckle configuration actuator 152 may be actuated to position the knuckle 150 out of the second position, and into the first position, depicted in FIG. 10. In the first position, the multi-use mount 160 is provided in a near vertical orientation, as shown, and would be suitable for implements that are provided with a vertical mounting bracket for attachment, such as carriage assembly with a pair of forks can be secured to the multi-use mount, and the trailer may be operated in self-propelled mode to operate similar to a forklift, or a telehandler, with movement of the forklift by operation of the drive mechanism, and positioning of the forks possible by tilting actuation and extension of the extension device, along with adjustments in the fork angles by the titling actuator of the multi-use mount. It is contemplated that the multi-use mount could similarly be attached to other implements, such as a bucket, and operated similarly to extend or controllably raise or lower the extension device, as well as to adjust the tilt of the implement, as will be familiar to those of skill in the art, for manipulating the implement.

In an exemplary application, where the multi-use mount 160 is attached to and supporting a storage bin 80, it is contemplated that building materials can be loaded and secured in the storage bin 80 at a location different than the work site. The load may be secured by the folding lid portions and closing the second end of the container. A truck (not shown) connects to the frame 10 using the trailer hitch 22 when in a lowered position and tows the trailer in the configuration depicted in FIG. 13. The operator positions the front wheel assembly 340 apart from the rear wheel assembly 310 using the extension assembly 380, and with care taken to ensure the trailer will not roll away, such as by setting the brakes or engaging the drive assembly, but in a stopped configuration, the hitch 22 may be removed from the tow vehicle, and raised to the position depicted in FIG. 1, thereby minimizing the length of the trailer, and not having the protruding trailer hitch extended out significantly beyond the frame 10. The front wheel assembly 340 and the rear wheel assembly 310 are set to drive and steer using the control system 60 and operated as a self-propelled vehicle, and the extension boom and knuckle manipulated for controlling the actions of an attached implement. Once the task is completed, the trailer 1 can then be reverted to a trailer mode, and may be towed behind a tow truck away from the work site.

In an exemplary embodiment, the multi-use mount 160 may have the carriage and forks mounted thereto. The storage bin 80 may provide a fork receiving bracket 84. The forks and carriage implement may be stored, when not in use, on the fork receiving bracket 84 of the storage bin 80. In an embodiment, the fork receiving brackets are positioned such that when the carriage for the fork assembly is secured onto the fork receiving brackets, the tines of the forks may be received underneath the storage bin, positioned between the telescoping legs 510, with the upright portions of the forks resting against the first end of the storage bin 80. It is contemplated that the operator may detach the storage bin 80 as described above, and as the extension device is removed from being underneath the storage bin 80, the user may then quickly engage the multi-use mount 160 with the carriage assembly for the forks, for providing the telehandler configuration depicted in FIG. 12.

In an embodiment, the telescoping legs 510 may be provided with a receiving catch, such as a loop provided at the foot of each telescoping leg. It is contemplated that each of the boom receiving bracket 82 and the telescoping legs may be provided on opposing sides of the container, such that the forks may be secured at a first end of the container bin 80, and attach the multi-use mount underneath the bin 80 to provide substantially the length of the bin 80 resting atop the lowered extension device 100, when the trailer 1 is operated in a towed configuration. In an embodiment, it is contemplated that a fork receiving bracket may be provided on each of the first end (as shown) and also on the second end (not shown) of the bin 80, with the intention being that the forks may be selective stored on either end of the bin and thus the operator is not limited to approaching the container from only one direction in order to mount the forks onto the multi-use mount 160.

In an embodiment, the outriggers of the trailer, positioned at the end of the frame away from the trailer hitch mount 22 may be provided with hook assemblies, positioned atop the respective feet of each outrigger. In such an embodiment, the trailer 1 may be positioned with the knuckle 150 in the second position, the fork and carriage mounted onto the multi-use mount 160. The forks may be advanced to be received in receiving slots of a provided container, or under a pallet. The container may be lifted by actuation of the extension device 100, and adjustments through the tilting actuators, as will be known with telehandler operations. With the container lifted, the extension device may be retracted, pulling the container towards the trailer hitch and largely supported on top of the extension device, and supported by the trailer from below. To remove the container, the extension device may be extended to advance the container away from the trailer hitch mount. The telescoping legs lowered, and the front outriggers adjusted such that the hooks of each outrigger will engage with the corresponding catch of the telescoping legs. As the extension device is retracted, the outrigger hooks will prevent the container from also moving towards the hitch mount 22, and thereby pulling the forks out from the receiving slots in the container. Once clear of the container, the forks may be repositioned to support the weight of the container from below, and the telescoping legs raised, such that the forks may be lowered to place the container at ground level.

In use, the operator uses the control system 60 to move the trailer 1 to a desired location on the work site using the drive system of the front wheel assembly 340 and the rear wheel assembly 310, as described above. The operator may now use the control system 60 to stabilize the trailer 1.

Once the operator has determined that the trailer 1 is in position to unload building materials from the storage bin 80, the operator can manage the stabilizers, as known and well understood by those skilled in the art, to stabilize and level the trailer 1. The operator then uses the control system 60 to control the extension device 100 and position of the storage bin 80.

The operator can use the control system 60 to control the vertical and horizontal position of the storage bin 80. In addition, the operator can slide the storage bin 80 horizontally with respect to frame 10.

The foregoing illustrates some of the possibilities for practicing the invention. Many other embodiments and fields of use for the trailer 1 are possible and within the scope and spirit of the invention. It is, therefore, intended that the foregoing description be regarded as illustrative rather than limiting.

What is claimed is:

1. A self-propelled trailer for towing by a power vehicle, comprising:
a frame forming an undercarriage chassis;
a tandem wheel assembly positioned under the undercarriage chassis and having a rear wheel assembly and a front wheel assembly, the tandem wheel assembly including at least one steering assembly, and at least one drive assembly, and
an extension assembly moving the front wheel assembly between trailing position and a self-propelled position where the rear wheel assembly and the front wheel assembly are positioned to equally support the undercarriage chassis and where the trailer can be moved by operation of the at least one drive assembly; and
an extension device pivotably mounted to the frame at a first end and having a repositionable knuckle and a multi-use mount at a second end of the extension device.

2. The self-propelled trailer of claim 1, wherein the frame is a tubular backbone frame formed as a generally hollow body extending between and supporting each of the front wheel assembly and the rear wheel assembly.

3. The self-propelled trailer of claim 1, wherein the frame is a ladder frame having a pair of generally parallel longitudinal rails with a plurality of cross braces extended therebetween, the frame supporting each of the front wheel assembly and the rear wheel assembly.

4. The self-propelled trailer of claim 1, wherein the multi-use mount has a carriage assembly mounted thereto.

5. The self-propelled trailer of claim 4, wherein the carriage assembly provides a pair of forks.

6. The self-propelled trailer of claim 1, wherein the multi-use mount has a container assembly mounted thereto.

7. The self-propelled trailer of claim 1, further comprising a control system providing a remote controller device, a power source selected from a combustion engine or a battery, the power source providing the source for motive power through the at least one drive assembly, and power for a plurality of linear actuators.

8. The self-propelled trailer of claim 7, wherein the plurality of linear actuators are hydraulic actuators, and the at least one drive assembly provides a hydraulic motor for rotating at least one wheel of the tandem wheel assembly.

9. The self-propelled trailer of claim 1, wherein the frame has pivot mount at a first end, with the extension device pivotably mounted to the pivot end.

10. The self-propelled trailer of claim 9, wherein the extension device is a three stage boom utilizing a chain drive mechanism for extending the extension device, and providing a first extension section, a second extension section that is telescopically received within the first extension section, and a third extension section that is telescopically received within the second extension section.

11. The self-propelled trailer of claim 10, wherein the extension device provides a tilting actuator extended between the frame and the extension device for pivoting the extension device at the pivot mount when the tilting actuator is extended.

12. The extension device having an extension device actuator for telescopically advancing and retracting the extension device.

13. The self-propelled trailer of claim 12, the extension device further having a knuckle configuration actuator for controllably positioning the knuckle.

14. The self-propelled trailer of claim 13, the extension device further having a mount tilting actuator for controllably positioning the mount upon the knuckle.

15. The self-propelled trailer of claim 7, wherein the tandem wheel assembly provides each of the front and rear wheel assemblies having drive assemblies for controllably driving the wheels, and each of the front and rear wheel assemblies are provided with a steering assembly.

16. The self-propelled trailer of claim 1, wherein the multi-use mount is configured to receive an implement thereon, the implement selected from the group consisting of storage bin, work platform basket, bucket, and forks.

17. The self-propelled trailer of claim 16, wherein the implement is a storage bin, the storage bin having a bracket receiver provided on the underside of the storage bin, the storage bin further providing a pair of telescoping support legs at a first end.

18. The self-propelled trailer of claim 17, wherein the storage bin further provides a fork receiving bracket for storage of the carriage assembly and forks when not secured to the multi-use mount.

19. The self-propelled trailer of claim 10, the extension device further providing a plurality of hydraulically operated actuators utilizing a plurality of hydraulic lines, the extension device providing a slidingly mounted manifold configured to provide strain relief for the hydraulic lines.

20. The self-propelled trailer of claim 19, wherein the slidingly mounted manifold is mounted to a first extension device, and sliding movement of the manifold is dampened by a spring or shock absorber.
